(19) United States
(12) Patent Application Publication
(10) Pub. No.: US 2022/0066501 A1
(43) Pub. Date: Mar. 3, 2022

(54) RETRACTABLE FEET FOR COMPUTING DEVICES

(71) Applicant: Hewlett-Packard Development Company, L.P., Spring, TX (US)

(72) Inventors: Andrew Elsey, Spring, TX (US); Chan Woo Park, Spring, TX (US)

(73) Assignee: Hewlett-Packard Development Company, L.P., Spring, TX (US)

(21) Appl. No.: 17/414,770

(22) PCT Filed: Dec. 21, 2018
(86) PCT No.: PCT/US2018/067029

§ 371 Date: Jun. 16, 2021

(51) Int. Cl. G06F 1/16; G06F 1/20

(52) U.S. Cl. CPC G06F 1/166; G06F 1/203; G06F 1/1616

(57) ABSTRACT

Examples disclosed herein provide a computing device. One example computing device includes a display member and a base member rotatably connected to the display member via a hinge. As an example, the base member includes a wedge disposed within the base member, wherein the wedge moves in a first direction when the display member is to be rotated open from a closed position to a first operating position. The base member includes a retractable foot aligned with the wedge, wherein the retractable foot extends from a bottom surface of the base member when the wedge moves in the first direction, when the display member is to be rotated open from the closed position to the first operating position.

### BACKGROUND

The emergence and popularity of mobile computing has made portable computing devices, due to their compact design and light weight, a staple in today's marketplace. Within the mobile computing realm, notebook computers, or laptops, are one of the most widely used devices and generally employ a clamshell-type design consisting of two members connected together at a common end via hinges, for example. In most cases, a first or display member is utilized to provide a viewable display to a user while a second or base member includes an area for user input (e.g., touchpad and keyboard). In addition, the viewable display may be a touchscreen (e.g., touchscreen laptop), allowing the user to interact directly with what is displayed by touching the screen with simple or multi-touch gestures.

### BRIEF DESCRIPTION OF THE DRAWINGS

FIGS. 1A-B illustrate a computing device including a retractable foot that extends to provide angled support when the computing device is used in certain operating positions, as an example;

FIGS. 2A-B illustrate the computing device in a first operating position as an example;

FIG. 3 illustrates the various components within a base member of the computing device, according to an example; and

FIGS. 4A-E illustrate various operating positions of a computing device, according to an example.

### DETAILED DESCRIPTION

Notebook computers may include a feature that allows the device to be “converted” from one style of use to at least another style of use. For example, a notebook computer may be converted from a laptop operating position, where the touchpad and keyboard are used as input components, to a tablet operating position, where the viewable display is used for both viewing and input. Such devices that serve this dual purpose may be called convertible laptops. Many form factors exist for convertible laptops. As an example of a convertible laptop, the hinges coupling the base and display members may allow the display member to flip 360 degrees when transitioning from laptop mode to tablet mode. As a result of flipping over the display member by 360 degrees, the display member and base member may be collapsed against each other in an open, folded position. As an example, in this open, folded position, a bottom surface of the base member may be covered by a back surface of the display member.

Examples disclosed herein provide a mechanism for computing devices, such as notebook computers, which provides an angled support, for example, when it is being operated in an operating position, such as laptop mode. The angled support allows for increased airflow below the computing device, which allows for better thermal performance. As a result, the improved thermal performance keeps the computing device cool, and cooler devices have the potential to have higher performance. In addition to the increased airflow, the mechanism provides an angled typing surface while the computing device is being used in an operating position such as laptop mode, creating a more ergonomic keyboard experience, as angling the typing surface may provide a more natural position for the user. As will be further described, the mechanism may correspond to a retractable foot that extends from a bottom surface of the base member of the computing device when it is being used in an operating position such as laptop mode, and then automatically retracts back into the bottom surface of the base member when the computing device is transitioned to another position. As an example, rotational motion from the hinge opening may cause the retractable foot to either extend or retract.

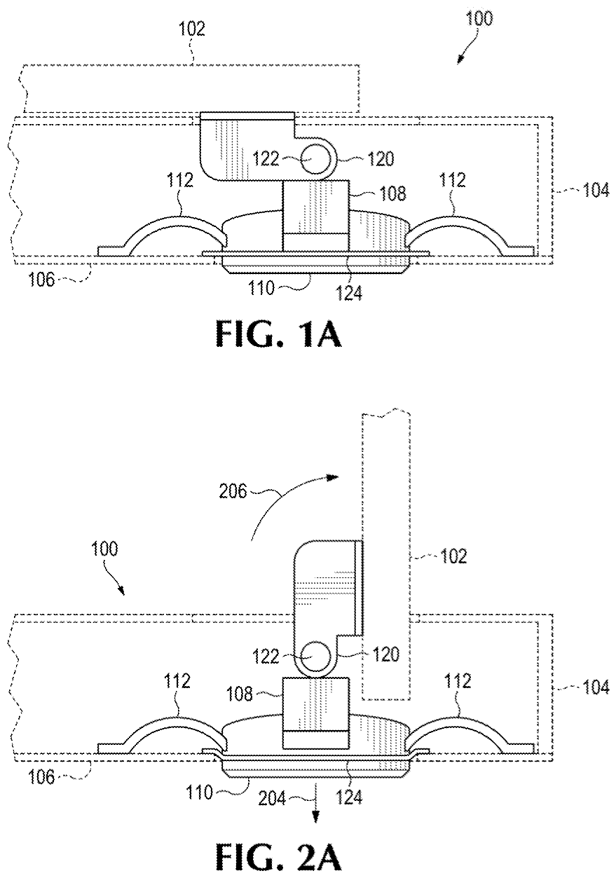

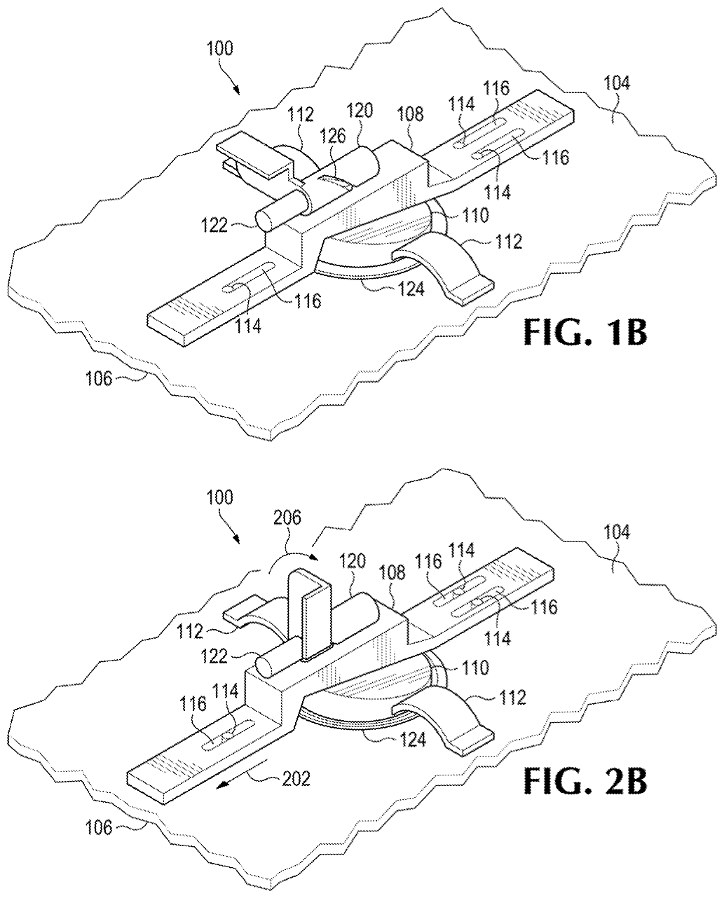

With reference to the figures, FIGS. 1A-B illustrate a computing device 100 including a retractable foot 110 that extends to provide angled support when the computing device 100 is used in certain operating positions, such as laptop mode, as an example. The computing device 100 includes a first member (base member 104) and a second member (display member 102) that are rotatably connected to each other, for example, via hinge 122. The base member 104 includes a top surface that may include input means for operation by a user, such as a keyboard and/or a touchpad, and a bottom surface 106 opposite the top surface. The display member 102 includes a display surface and a back surface opposite the display surface. As an example, the display surface of the display member 102 may be used for viewing the video output of the laptop 100, and include input means for operation by a user, such as a touchscreen.

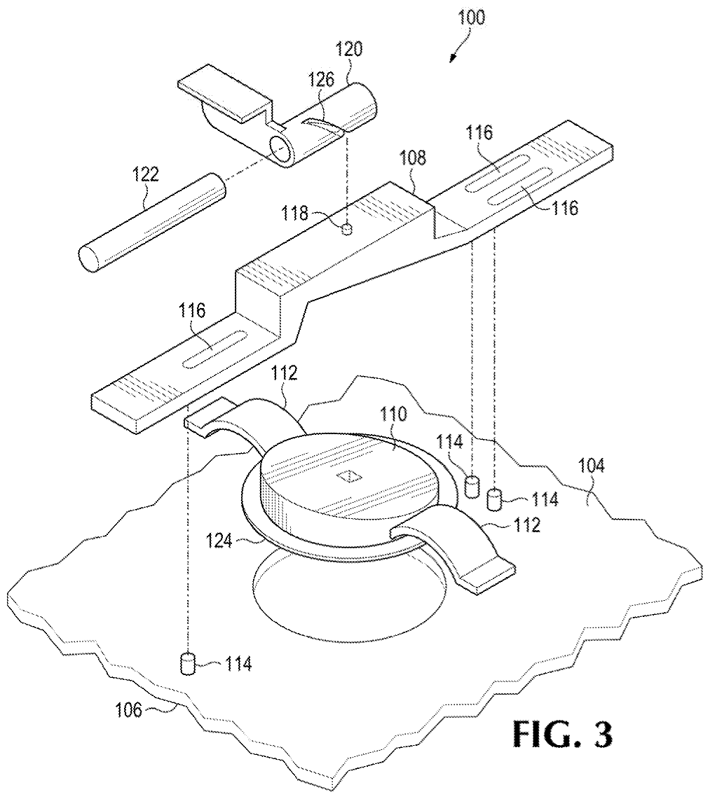

As will be further described, the retractable foot 110 is mechanically linked to a rotational motion of shaft 120 around the hinge 122 of the computing device 100. For example, as the display member 102 is rotated open from the closed position illustrated in FIG. 1A to a first operating position (e.g., laptop mode illustrated in FIG. 2A), the retractable foot 110 extends from the bottom surface 106 of the base member 104. As an example, laptop mode may correspond to a position where the display member 102 is opened to an appropriate angle for a user, and where the touchpad and keyboard on the top surface of the base member 104 may be used as input components. By extending from the bottom surface 106 of the base member 104, the retractable foot 110 provides an angled support to the base member 104, increasing airflow below the computing device 100 to allow for better thermal performance, and providing an angled typing surface while the computing device 100 is being used in an operating position such as laptop mode, as described above. Similarly, when the display member 102 is returned to the closed position illustrated in FIG. 1A, the retractable foot 110 retracts back into the bottom surface 106 of the base member 104. As an example, the retractable foot 110 may include flexible arms 112 disposed within the base member 104 to retract the foot 110 back into the bottom surface 106 of the base member 104. The number of retractable feet used may vary from what is illustrated.

Referring to FIG. 1B, the computing device 100 includes a wedge 108 disposed within the base member 104 (side profile of wedge 108 illustrated in FIG. 1A). As an example, the wedge 108 may be constrained within the base member 104 to move along a single axis. As illustrated, openings 116 along the sides of the wedge 108 may be coupled to pins 114 within the base member 104, for example, along the bottom surface 106. As a result, such arrangement may limit movement of the wedge 108 along the single axis. As will be further described, rotational motion of the shaft 120, for example, as the display member 102 is rotated opened and closed, may correlate to linear motion of the wedge 108 along the single axis (e.g., X axis). X-dimension motion of the wedge 108 may then be translated to Z-dimension motion of retractable foot 110, for example, by either extending or retracting.

FIG. 3 illustrates the various components within the base member 104 of the computing device 100, according to an example. As an example, a groove 126 may wrap around the shaft 120, which is then coupled to a pin 118 located on the wedge 108. As a result, when the display member 102 is rotated opened and closed, resulting in the rotational motion of the shaft 120 described above, the pin 118 following the groove 126 results in the linear motion of the wedge 108, for example, along the X-axis. As a result, when the display member 102 is to be rotated open from a closed position, as illustrated by arrow 206 in FIG. 2A, the wedge 108 moves in a first direction, as illustrated by arrow 202 in FIG. 2B. Similarly. when the display member 102 is to be rotated back to the closed position, as illustrated in FIG. 1A, the pin 118 may follow the groove in the opposite direction causing the wedge to move in a second direction opposite the first direction 202.

As an example, in order for the X-dimension motion of the wedge 108 to translate to the Z-dimension motion of the retractable foot 110, a profile along the top of the retractable foot 110 may match with the profile along the bottom of the wedge 108. As illustrated in in FIG. 3, the profile along the bottom of the wedge 108 may be angled to match with the profile along the top of the retractable foot 110. As a result, when the wedge 108 moves in the first direction 202, for example, when the display ember 102 is rotated open (indicated by arrow 206), the retractable foot 110, aligned with the wedge 108, may extend from the bottom surface 106 of the base member 104, indicated by arrow 204 in FIG. 2A, providing an angled support for the computing device 100. Similarly, when the wedge 108 moves in the second direction, opposite from the first direction 202, for example, when the display member 102 is rotated back to a closed position, the retractable foot 110, following the profile of the wedge, may retract back into the bottom surface 106 of the base member 104. As an example, the retractable foot 110 may include a skirt 124, for example, made out of silicone, to prevent fluid ingress in the base member 104. As illustrated in FIG. 2A, when the retractable foot 110 extends from a retracted position, the skirt 124 is flexible to allow for the movement of the retractable foot 110.

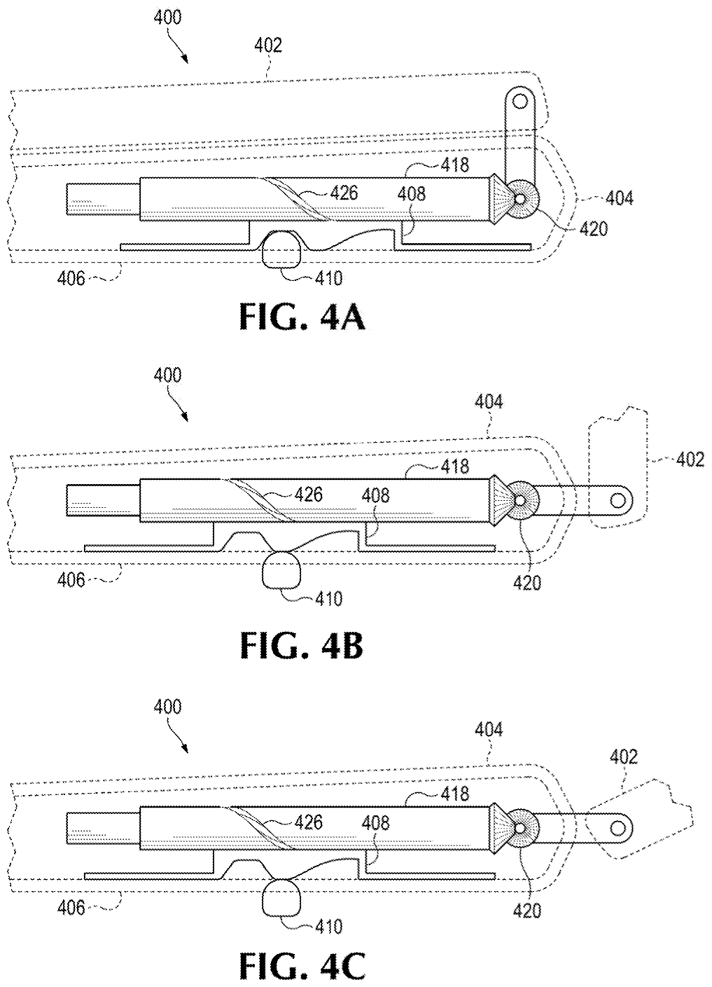

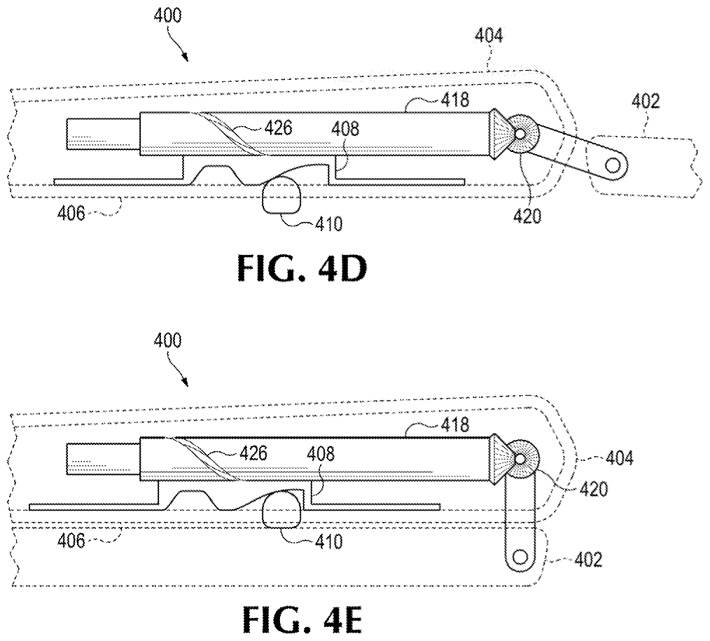

FIGS. 4A-E illustrate various operating positions of a computing device 400, according to an example. As mentioned above, notebook computers may include a feature that allows the device to be “converted” from one style of use to at least another style of use. For example, computing device 400 may be converted from a laptop operating position, illustrated in FIG. 4B, where the touchpad and keyboard are used as input components, to a tablet operating position, illustrated in FIG. 4E, where the viewable display is used for both viewing and input. Similar to retractable foot 110 of computing device 100, computing device 400 includes a retractable foot 410 that extends to provide angled support when the computing device 400 is used in certain operating positions, such as laptop mode, as an example. As will be further described, the retractable foot 410 may extend from a bottom surface 406 of the base member 404 when it is being used in an operating position such as laptop mode, and then automatically retracts back into the bottom surface of the base member when the computing device is transitioned to another operating position, such as tablet mode.

As an example, the computing device 400 includes a wedge 408 disposed within the base member 404. As an example, the wedge 408 may be constrained within the base member 404 to move along a single axis, similar to wedge 108 of computing device 100. For example, openings along the sides of the wedge 408 may be coupled to pins within the base member 404 (not illustrated). As a result, such arrangement may limit movement of the wedge 408 along the single axis. As an example, rotation of the display member 402 around the base member 404, may correlate to linear motion of the wedge 408 along the single axis. The single dimension motion of the wedge 408 may then be translated to Z-dimension motion of retractable foot 410, for example, by either extending or retracting.

As illustrated, the retractable foot 410 may be mechanically linked to rotation of the display member 402 around the base member 404. Starting at FIG. 4A, when the display member 402 is rotated open from a closed position, element 420 may cause element 418 to rotate. As an example, a groove 426 may wrap around element 418, which is then coupled to a pin (not illustrated) located on the wedge 408 (similar to pin 118 on wedge 108). As a result, when the display member 402 is rotated opened and closed, resulting in the rotational motion of element 418, the pin on wedge 408 follows the groove 426, resulting in the linear motion of the wedge 408, for example, along the single axis. As a result, when the display member 402 is to be rotated open from a closed position, for example, to the laptop position illustrated in FIG. 4B, the wedge 408 moves in a first direction. Similarly, when the display member 402 is to be rotated back to the closed position, as illustrated in FIG. 4A, the pin on wedge 408 may follow the groove 426 in the opposite direction, causing the wedge to move in a second direction opposite the first direction.

As an example, in order for the single dimension motion of the wedge 408 to translate to the Z-dimension motion of the retractable foot 410, a profile along the bottom of the wedge 408 may provide a path for the retractable foot 410 to follow. For example, if the retractable foot 410 is to extend while in laptop mode and retract while in tablet mode, the profile along the bottom of the wedge 408 may provide the path for the retractable foot 410 to extend and retract accordingly. For example, referring to FIG. 4B, while the computing device 400 is transitioned to laptop mode, the wedge 408 moves in a first direction, and the profile along the bottom of the wedge 408 extends the retractable foot 410 out, providing an angled support for the computing device 400. However, while the computing device 400 is transitioned further to tablet mode, as indicated by FIGS. 4C to 4E, the wedge 408 continues to move in the first direction, and the profile along the bottom of the wedge 408 causes the retractable foot 410 to retract back into the bottom surface 406 of the base member 404. As a result, while the wedge 408 moves in the first direction, the profile along the bottom of the wedge 408 causes the retractable foot 410 to extend from the bottom surface 406 of the base member 404 while the display member 402 is to be rotated open from the closed position to the first operating position (e.g., laptop mode), and then retract back into the bottom surface 406 of the base member 404 while the display member 402 is to be rotated further to the second operating position (e.g., tablet mode).

It should be understood that examples described herein below may include various components and features. It should also be understood that, in the following description, numerous specific details are set forth to provide a thorough understanding of the examples. However, it should be understood that the examples may be practiced without limitations to these specific details. In some instances, well known methods and structures may not be described in detail to avoid unnecessarily obscuring the description of the examples. Also, the examples may be used in combination with each other.

Reference in the specification to “an example” or similar language means that a particular feature, structure, or characteristic described in connection with the example is included in at least one example, but not necessarily in other examples. The various instances of the phrase “in one example” or similar phrases in various places in the specification are not necessarily all referring to the sane example.

It should be understood that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

What is claimed is:

1. A computing device comprising:
a display member comprising a display surface and a back surface opposite the display surface; and
a base member rotatably connected to the display member via a hinge, wherein the base member comprises:
a top surface;
a bottom surface opposite the top surface;
a wedge disposed within the base member, wherein the wedge moves in a first direction when the display member is to be rotated open from a closed position to a first operating position; and
a retractable foot aligned with the wedge, wherein the retractable foot extends from the bottom surface of the base member when the wedge moves in the first direction, when the display member is to be rotated open from the closed position to the first operating position.

2. The computing device of claim 1, wherein, when the display member is to be rotated back to the closed position:
the wedge moves in a second direction opposite the first direction, and
the retractable foot, following a profile of the wedge, retracts back into the bottom surface of the base member.

3. The computing device of claim 2, wherein, when the display member is to be rotated further open from the first operating position to a second operating position:
the wedge continues to move in the first direction, and
the retractable foot, following the profile of the wedge, retracts back into the bottom surface of the base member.

4. The computing device of claim 3, wherein, while the wedge is to move in the first direction, the profile of the wedge is to cause the retractable foot to:
extend from the bottom surface of the base member while the display member is to be rotated open from the closed position to the first operating position, and
retract back into the bottom surface of the base member while the display member is to be rotated further to the second operating position.

5. The computing device of claim 3, wherein the second operating position comprises the back surface of the display member making contact with the bottom surface of the base member.

6. The computing device of claim 2, wherein, as the computing device is to transition between the closed position and an open position, the wedge comprises a pin to follow a groove, wherein:
as the display member is to be rotated to the open position, the pin following the groove is to cause the wedge to move in the first direction, and
as the display member is to be rotated back to the closed position, the pin following the groove is to cause the wedge to move in the second direction,

7. A computing device comprising:
a display member comprising a display surface and a back surface opposite the display surface; and
a base member rotatably connected to the display member via a hinge, wherein the base member comprises:
a top surface;
a bottom surface opposite the top surface;
a wedge disposed within the base member, wherein the wedge comprises a pin to follow a groove, wherein as the display member is to be rotated open from a closed position to a first operating position, the pin following the groove is to cause the wedge to move in a first direction; and
a retractable foot aligned with the wedge, wherein the retractable foot extends from the bottom surface of the base member when the wedge moves in the first direction, when the display member is to be rotated open from the closed position to the first operating position.

8. The computing device of claim 7, wherein as the display member is to be rotated back to the closed position:
the pin following the groove is to cause the wedge to move in a second direction opposite the first direction, and
the retractable foot, following a profile of the wedge, retracts back into the bottom surface of the base member.

9. The computing device of claim 8, wherein, when the display member is to be rotated further open from the first operating position to a second operating position:
the pin following the groove is to cause the wedge to continue to move in the first direction, and
the retractable foot, following the profile of the wedge, retracts back into the bottom surface of the base member.

10. The computing device of claim 9, wherein, while the wedge is to move in the first direction, the profile of the wedge is to cause the retractable foot to:
extend from the bottom surface of the base member while the display member is to be rotated open from the closed position to the first operating position, and
retract back into the bottom surface of the base member while the display member is to be rotated further to the second operating position.

11. The computing device of claim 9, wherein the second operating position comprises the back surface of the display member making contact with the bottom surface of the base member.

12. A computing device comprising:
a display member comprising a display surface and a back surface opposite the display surface; and
a base member rotatably connected to the display member via a hinge, wherein the base member comprises:
a top surface;
a bottom surface opposite the top surface;
a wedge disposed within the base member, wherein the wedge:
moves in a first direction when the display member is to be rotated open from a closed position to an open position, and
moves in a second direction opposite the first direction when the display member is to be rotated back to the closed position; and
a retractable foot to switch between extending from and retracting back into the bottom surface of the base member by following a profile of the wedge.

13. The computing device of claim 12, wherein, while the wedge is to move in the first direction, the profile of the wedge is to cause the retractable foot to:
extend from the bottom surface of the base member while the display member is to be rotated open from the closed position to a first operating position, and
retract back into the bottom surface of the base member while the display member is to be rotated further to a second operating position.

14. The computing device of claim 13, wherein the second operating position comprises the back surface of the display member making contact with the bottom surface of the base member.

15. The computing device of claim 12, wherein, as the computing device is to transition between the closed position and the open position, the wedge comprises a pin to follow a groove, wherein:
as the display member is to be rotated to the open position, the pin following the groove is to cause the wedge to move in the first direction, and
as the display member is to be rotated back to the closed position, the pin following the groove is to cause the wedge to move in the second direction.
